(19) United States
(12) Patent Application Publication
(10) Pub. No.: US 2024/0275876 A1
(43) Pub. Date: Aug. 15, 2024

(54) CONNECTING ATTACHMENT AND MOBILE DEVICE ATTACHMENT ASSEMBLY

(71) Applicant: EVOLUTIVE LABS CO., LTD., Taipei City (TW)

(72) Inventor: CHING-FU WANG, Taichung City (TW)

(21) Appl. No.: 18/302,006

(22) Filed: Apr. 18, 2023

(30) Foreign Application Priority Data
Feb. 9, 2023 (TW) 112104536

(51) Int. Cl. H04M 1/02; H04M 1/11

(52) U.S. Cl. CPC H04M 1/0279; H04M 1/11

(57) ABSTRACT

A connecting attachment is provided. The connecting attachment includes a main body, an extending part and a wireless communicating component. The main body is adapted to be disposed between a mobile device and a case. The case is configured to detachably accommodate the mobile device. The extending part is connected to the main body and extrudes with respect to the case. The wireless communicating component is disposed on the main body. Besides, a mobile device attachment assembly including the connecting attachment is also provided.

### CROSS-REFERENCE TO RELATED APPLICATION

This non-provisional application claims priority under 35 U.S.C. § 119(a) on Patent Application No. 112104536 filed in Taiwan, R.O.C. on Feb. 9, 2023, the entire contents of which are hereby incorporated by reference.

### BACKGROUND OF THE INVENTION

### 1. Field of the Invention

The present disclosure relates to a mobile device attachment, and in particular to a connecting attachment and a mobile device attachment assembly comprising the aforementioned connecting attachment.

### 2. Description of the Related Art

With the rapid development of technology, people's demand for wireless transmission technology is also increasing, including access credentials for specific places, clock-in when arriving at the company, transportation and mobile payment for daily life consumption. The wireless transmission technology can be seen to play a part in the above activities.

### BRIEF SUMMARY OF THE INVENTION

Taking the Near Field Communication (NFC) component as an example, many smartphone manufacturers on the market currently integrate the near field communication antenna into the smartphone, so that users can directly close the antenna area of the smartphone to the terminal of the sensing application when paying, and thus contactless point-to-point data transmission can be achieved. However, because of the limitations of region, platform or communication protocol, when the sensing terminal only corresponds to the wireless communication of part of the smartphone (e.g., only Google Pay is applicable and Apple Pay cannot be used), or the smartphone used by the user cannot integrate the near field communication function, the user needs to additionally carry the corresponding near field communication sensor (such as a card), resulting in inconvenience in use.

The inventor devoted his mind to carefully research, and then developed a connecting attachment with wireless communicating elements and a mobile device attachment assembly including the above connecting attachment, with a view to achieving the effect of eliminating the need for users to carry additional wireless communicating components.

The disclosure provides a connecting attachment includes a main body, an extending part and a wireless communicating component. The main body is adapted to be disposed between a mobile device and a case, and the case is configured to detachably accommodate the mobile device; the extending part is connected to the main body and extrudes with respect to the case. The wireless communicating component is disposed on the main body.

In one embodiment, the connecting attachment further includes a bonding part, the wireless communicating component is bonded to the main body through the bonding part, and the extending part is disposed at one side of the main body.

In one embodiment, the main body is a rectangular sheet and has two long sides and two short sides adjacent to the long sides, and the extending part is disposed at one of the long sides.

In one embodiment, the connecting attachment further includes a hanging component, the extending part includes two end parts, one of the end parts is connected to the main body, and the hanging component is disposed at the other of the end parts.

In one embodiment, the other of the end parts forms a pierced hole thereon, and the hanging component perforates into the pierced hole.

In one embodiment, a side projection of the main body and a side projection of the extending part have an angle therebetween.

In one embodiment, the case includes a bottom wall, and the bottom wall forms an attachment accommodating part thereon, the main body is adapted to be disposed in the attachment accommodating part and abutted against the mobile device.

In one embodiment, the case further includes a side wall, the side wall is connected to a perimeter of the bottom wall and suitable for surrounding the mobile device, the side wall forms a through hole thereon, and the extending part is suitable for perforating into the through hole.

Further, the present disclosure further provides a mobile device attachment assembly including a case and the above-mentioned connecting attachment, wherein the case is configured to detachably accommodate the mobile device; the main body is adapted to be disposed between the mobile device and the case, and the extending part is connected to the main body and extrudes with respect to the case.

In one embodiment, the case includes a bottom wall, and the bottom wall forms an attachment accommodating part thereon, the connecting attachment is disposed in the attachment accommodating part and abutted against the mobile device.

In one embodiment, the case further includes a side wall, the side wall is connected to a perimeter of the bottom wall and suitable for surrounding the mobile device, the side wall forms a through hole thereon, and the extending part is suitable for perforating into the through hole.

In one embodiment, a chamfering part is formed between the bottom wall and the side wall, and the chamfering part is recessed between the bottom wall and the through hole.

In one embodiment, the bottom wall further forms a limiting part thereon, the limiting part is configured to be adjacent to the attachment accommodating part, and at least one portion of the limiting part is protruding relative to a surface of the attachment accommodating part.

In one embodiment, a surface of the attachment accommodating part forms an anti-slip feature thereon.

Accordingly, the connecting attachment and the mobile device attachment assembly of the present disclosure can dispose the main body with the wireless communicating component between the mobile device and the housing, so that the user does not need to carry additional wireless communicating components, thereby improving the convenience of use.

To facilitate understanding of the characteristics and advantages of this present disclosure, embodiments together with the attached drawings for the detailed description of the present disclosure are provided.

### BRIEF DESCRIPTION OF THE DRAWINGS

FIG. 1 is a schematic perspective view of a mobile device attachment assembly according to an embodiment of the present disclosure assembling with a mobile device.

FIG. 2 is a schematic perspective view of the connecting attachment in FIG. 1.

FIG. 3 is a schematic side view of FIG. 2.

FIG. 4 is a schematic top view of the case in FIG. 1.

FIG. 5 is a schematic sectional view of the case along the A-A section of FIG. 4.

FIG. 6 is a schematic local sectional view along the B-B section of FIG. 4 after the assembly of the mobile device attachment assembly and the mobile device in FIG. 1.

FIG. 7 is a schematic top view of the connecting attachment of another embodiment of the present disclosure.

FIG. 8 is a sectional view of the connecting attachment along the C-C section of FIG. 7.

FIG. 9 is a schematic top view of the connecting attachment of another embodiment of the present disclosure.

FIG. 10 is a schematic sectional view of the connecting attachment along the D-D section of FIG. 9.

### DETAILED DESCRIPTION OF THE INVENTION

The aforementioned and other technical contents, characteristics and effects of the present disclosure can be clearly presented by the detailed description of preferable embodiments together with the attached drawings. It is worth mentioning that the direction terms mentioned in the following embodiments, such as: top, bottom, left, right, front or rear are only referred to the direction of the drawings. Therefore, the directional terms used are intended to illustrate, not to limit, the disclosure. In addition, in the following embodiments, the same or similar components will use the same or similar reference numerals.

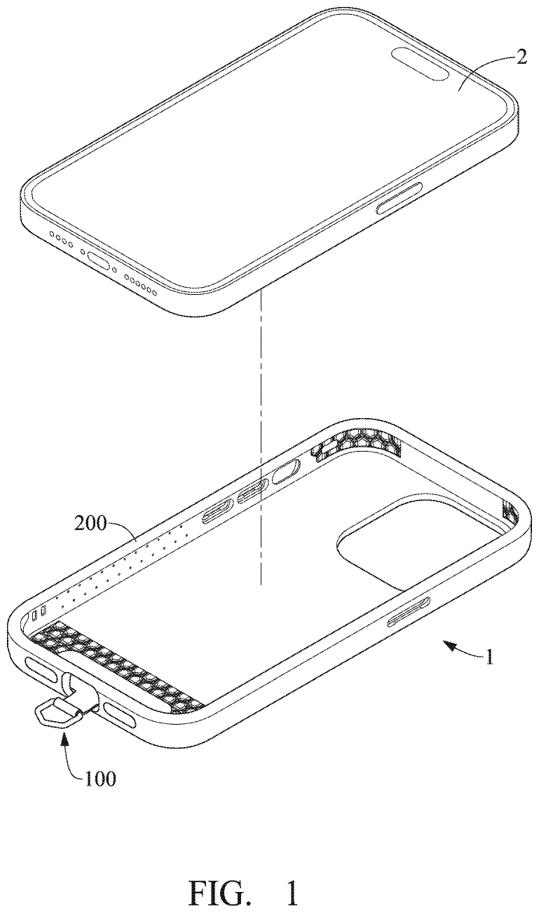

Referring to FIG. 1, FIG. 1 is a schematic perspective view of a mobile device attachment assembly according to an embodiment of the present disclosure assembling with a mobile device. The mobile device attachment assembly 1 of the present embodiment is suitable for a mobile device 2, wherein the mobile device 2, for example, is a smartphone, tablet, music Walkman, e-book or personal digital assistant, and the mobile device attachment assembly 1 includes a connecting attachment 100 and a case 200, wherein the connecting attachment 100 is adapted to be disposed between the mobile device 2 and the case 200, and the case 200, for example, is a mobile phone case and is used to detachably accommodate the mobile device 2.

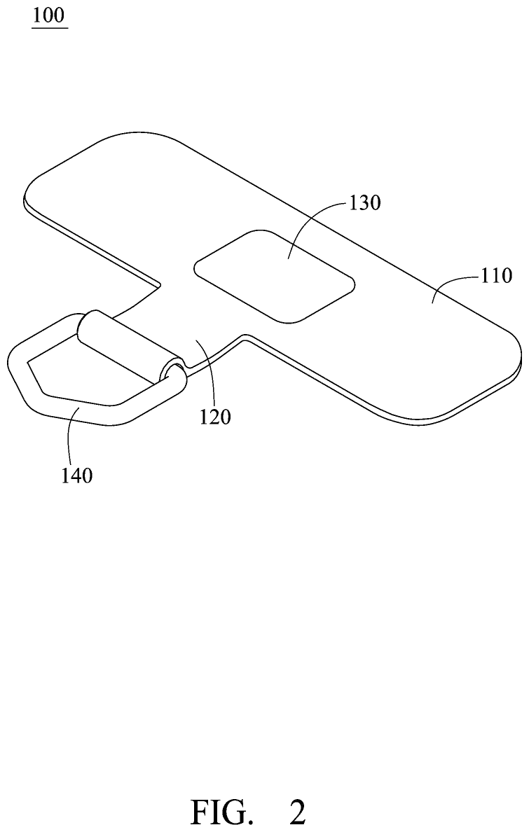

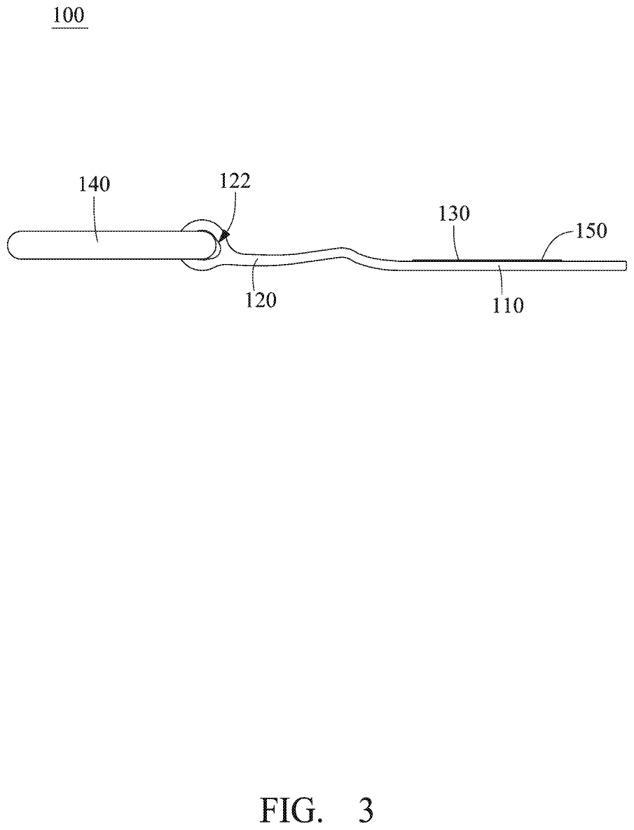

Referring to FIG. 2 and FIG. 3, FIG. 2 is a schematic perspective view of the connecting attachment in FIG. 1, and FIG. 3 is a schematic side view of FIG. 2. The connecting attachment 100 of the present embodiment, for example, is an adapter and includes a main body 110, an extending part 120 and a wireless communicating component 130, wherein the main body 110 is adapted to be disposed between a back side of the mobile device 2 and the case 200, the extending part 120 is connected to the main body 110 and extrudes with respect to the case 200, and the wireless communicating component 130 is disposed on the main body 110. In some possible embodiments, the connecting attachment 100 may further include a hanging component 140, wherein the hanging component 140 may be a strap, a hanging ring providing a connection for a strap, a pendant, a tassel and the like attachments, the present disclosure is not limited in this regard. In particular, the extending part 120 may include two end parts, wherein one end part is connected to the main body 110, and the hanging component 140 is disposed at the other end part of the extending part 120. Further, as shown in FIG. 3, the end part of the extending part 120 disposed with the hanging component 140 forms a pierced hole 122 thereon, and the hanging component 140 perforates into the pierced hole 122. In other embodiments, the extending part 120 may include a body part connected to the two end parts, and the hanging component 140 may also be disposed at a part of the main body part extruding with respect to the case 200, in short, the hanging component 140 only needs to be disposed at the part of the extending part 120 extruding with respect to the case 200. By such a configuration, when a user disposes the main body 110 between the mobile device 2 and the case 200, the hanging component 140 perforating into the pierced hole 122 may extrude with respect to the outside of the mobile device 2 and the case 200, so that the user can easily take the mobile device attachment assembly 1 and the mobile device 2, or may improve the overall aesthetics of the mobile device attachment assembly 1.

In detail, as shown in FIG. 2, the main body 110 is a rectangular sheet and has two long sides and two short sides adjacent to the long side, and the extending part 120 is disposed at a central portion of one of the long sides. Thus, when the connecting attachment 100 is assembled and the extending part 120 is configurated to be adjacent to the edge of the case 200 and extrudes with respect to the case 200, the area where the main body 110 and the magnetic components or antennas included in the mobile device 2 itself overlap each other may be reduced, thereby avoiding affecting the magnetic attraction, charging or other built-in wireless antenna communication functions of the mobile device 2.

In addition, in some possible embodiments, a side projection of the main body 110 and a side projection of the extending part 120 may have an angle therebetween, that is, the extending part 120 may be deflected in one direction relative to the main body 110, but the two remain smoothly connected. By such a configuration, when the user takes the mobile device attachment assembly 1 through the extending part 120 and the extending part 120 is bent relative to the main body 110, the connecting attachment 100 designed with a reserved deflection angle may have greater bending resistance and flexural strength, avoiding the extending part 120 from being squeezed by the mobile device 2 and the case 200, and thus stress concentration is produced to result in fracture at a turning place. Further, although the concave directions of the main body 110 and the extending part 120 are the same in the present embodiment, in other possible embodiments, the side projections of the main body 110 and the extending part 120 may also be opposite concave direction, that is, the above angle may be an acute angle or an obtuse angle, so that the effect of preventing stress concentration can also be achieved. Alternatively, based on production efficiency considerations, the main body 110 and the extending part 120 may also be flat members, and form a predetermined shape by tightly pressing the mobile device 2 and the case 200 hereafter, the present disclosure is not limited in this regard.

In order to allow the user not to carry additional wireless communicating components, the wireless communicating component 130 of the present embodiment is disposed on the main body 110, wherein the wireless communicating component 130, for example, is a chip containing an NFC antenna, an RFID chip or a carrier printed with a one-dimensional or two-dimensional barcode. Thus, when the user disposes the connecting attachment 100 between the mobile device 2 and the case 200, not only can the mobile device attachment assembly 1 and the mobile device 2 be taken by the extending part 120 extruding with respect to the case 200, but the wireless communicating component 130 located on the main body 110 also can be directly close to a sensing terminal for sensing when the user needs to use wireless communication (e.g., mass transportation card, mobile payment, access certificate sensing), it is quite simple and convenient. At the same time, since the main body 110 is disposed between the mobile device 2 and the case 200, the wireless communicating component 130 is protected by the mobile device 2 and the case 200 when in use or not in use, and is not easily lost or damaged by collision with other external components.

Further, the wireless communicating component 130 of the present embodiment may be disposed on the main body 110 by a printed type. As shown in FIG. 3, the connecting attachment 100 further includes a printing part 150, wherein the material of the main body 110, for example, is nylon, and the wireless communicating component 130 is a portion of the printing part 150, and the printing part 150 together with the wireless communicating component 130 is jointly printed on a surface of the main body 110. By such a configuration, after the main body 110 is formed, the wireless communicating component 130 may be heavily disposed on the main body 110 by a device of circuit wiring or printing a barcode, improving the production efficiency of the connecting attachment 100, and in addition to the wireless communicating component 130, other parts of the printing part 150 may also be printed with cartoon characters, flowers and trees and other patterns, when the case 200 is transparent and visible and the user disposes a side of the main body 110 setting the printing part 150 towards the case 200, the user and others can see the printing part 150 with beautiful visual effects from outside the case 200, adding the use of the connecting attachment 100. However, in other possible embodiments, the printing part 150 may also simply include only a wireless communicating component 130 without other visual patterns, and the user may also dispose a side of the main body 110 having the printing part 150 towards a back side of the mobile device 2, the present disclosure is not limited in this regard.

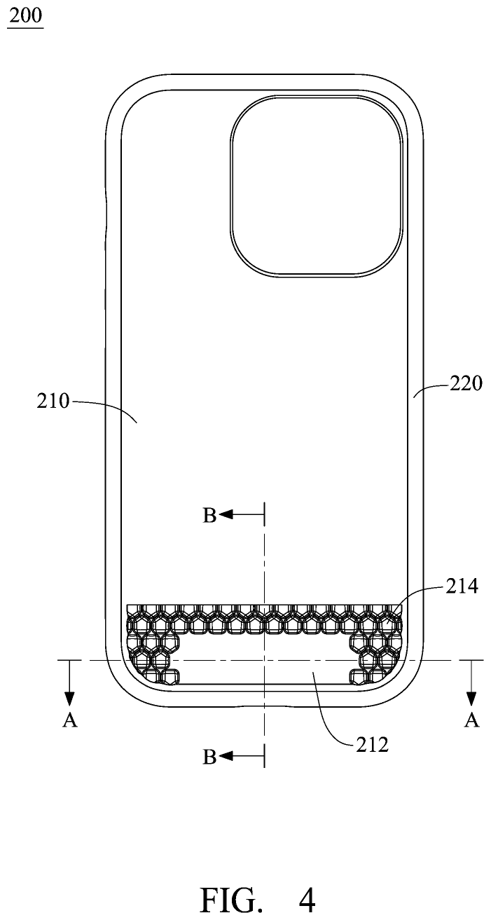

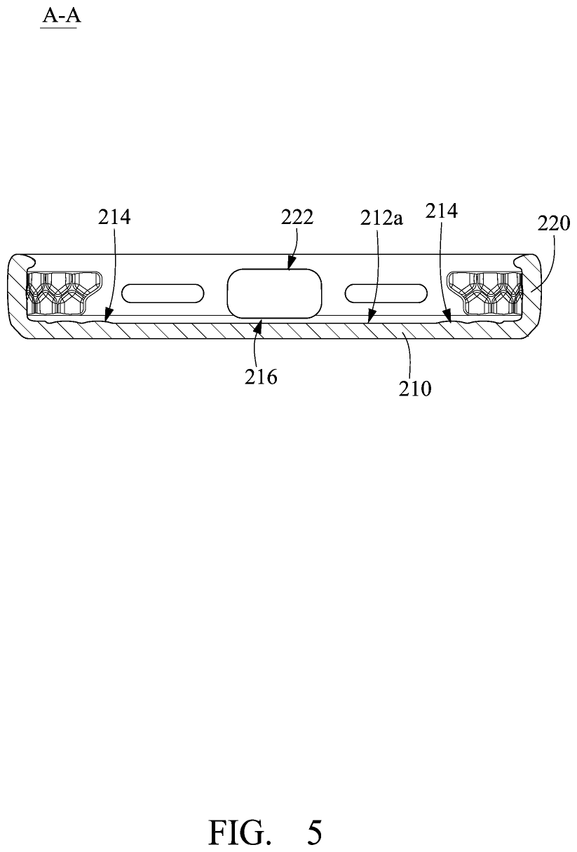

Referring to FIG. 4 and FIG. 5, FIG. 4 is a schematic top view of the case in FIG. 1, and FIG. 5 is a schematic sectional view of the case along the A-A section of FIG. 4. In detail, the case 200 may include a bottom wall 210, and the bottom wall 210 forms an attachment accommodating part 212 thereon, wherein the attachment accommodating part 212, for example, is a recessed groove with respect to the other parts of the bottom wall 210 and corresponds to the size of the main body 110, but the present disclosure is not limited thereto. By such a configuration, when the user disposes the connecting attachment 100 between the mobile device 2 and the case 200, the main body 110 may be disposed exactly in the attachment accommodating part 212 and abutted against the back side of the mobile device 2, so it will not produce excessive relative displacement and cause inconvenience when using the wireless communication function.

As shown in FIG. 5, in some possible embodiments, a surface of the attachment accommodating part 212 may form an anti-slip feature 212a thereon, wherein the anti-slip feature 212a, for example, is a knurling with a high friction after roughening treatment. Thus, when the main body 110 is disposed in the attachment accommodating part 212, the anti-slip feature 212a prevents the connecting attachment 100 from sliding relative to the mobile device 2 and the case 200, further improving the stability of the connecting attachment 100 in use.

As shown in FIGS. 4 and 5, in some possible embodiments, the bottom wall 210 further forms a limiting part 214, wherein the limiting part 214 is configured to be adjacent to the attachment accommodating part 212, and at least one portion of the limiting part 214 is protruding relative to the surface of the attachment accommodating part 212. In particular, the limiting part 214, for example, includes a plurality of interconnected protruding structures, in the case of the bottom wall 210 setting the limiting part 214, even if the surface of the attachment accommodating part 212 is not recessed relative to the other parts of the bottom wall 210, the main body 110 may still be accommodated in the attachment accommodating part 212 through the limiting part 214 blocking. However, in other possible embodiments, if the user fails to have the need to replace other connecting attachments 100, the main body 110 may also be directly fixed to the attachment accommodating part 212 by bonding or welding, the present disclosure is not limited in this regard.

On the other hand, the case 200 further includes a side wall 220, wherein the side wall 220 is connected to a perimeter of the bottom wall 210 and bent relative to the bottom wall 210, when the mobile device 2 is accommodated in the case 200, the side wall 220 is suitable for surrounding the mobile device 2. Further, as shown in FIG. 5, the side wall 220 forms a through hole 222 thereon, and the extending part 120 is suitable for perforating into the through hole 222, in the present embodiment, the through hole 222, for example, is a hole provided for the power line/signal line of the mobile device 2 to perforate into, but in other possible embodiments, the through hole 222 may also be a sound hole or button slot corresponding to a microphone or button position of the mobile device 2, the present disclosure is not limited in this regard. By such a configuration, the case 200 may be designed to closely surround the side of the mobile device 2 without leaving a gap equivalent to the thickness of the extending part 120, only need to perforate the extending part 120 through the through hole 222 and protrude from the case 200, thereby reducing the volume of the case 200 and increasing the bonding strength between the mobile device 2 and the case 200. At the same time, the length of the long side of the main body 110 is set to be greater than a size of the through hole 222 in the direction of the long side, so that when the user takes the mobile device attachment assembly 1, the risk that the main body 110 slips out of the through hole 222 to cause the mobile device 2 and the case 200 to fall down can be prevented, furthermore, in other embodiments, the main body 110 may also be a triangle, polygon, or even irregular shape, the extending part 120 may be connected to the side or corner of the main body 110, as long as the width of the portion of the main body 110 close to the extending part 120 is greater than the size of the through hole 222 in the direction of the long side, the effect of preventing the main body 110 slipping out of the through hole 222 can be achieved.

In some possible embodiments, a chamfering part 216 is formed between the bottom wall 210 and the side wall 220, wherein the chamfering part 216 may be a ring of chamfer around a connecting boundary of the bottom wall 210 and the side wall 220, and the chamfering part 216 is recessed between the bottom wall 210 and the through hole 222, it may prevent excessive bending of the main body 110 or the extending part 120 when the extending part 120 perforates into the through hole 222.

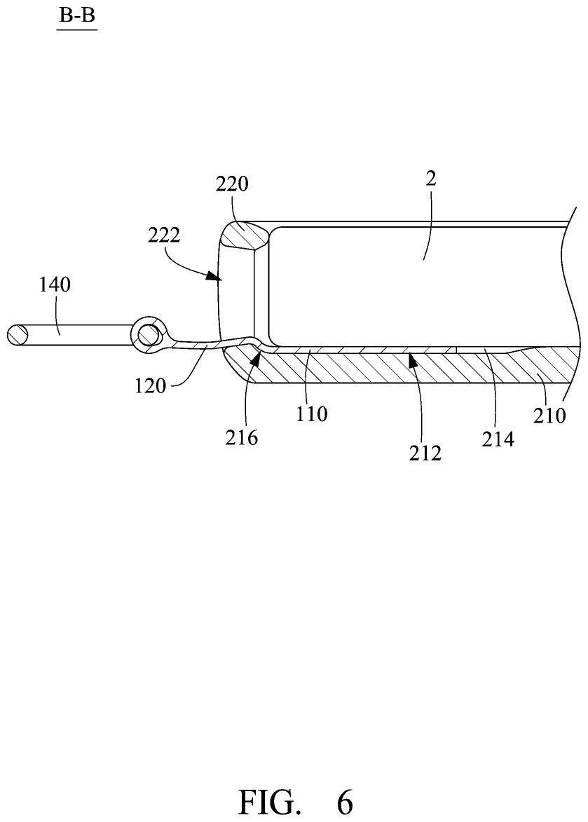

Referring to FIG. 6, FIG. 6 is a schematic local sectional view along the B-B section of FIG. 4 after the assembly of the mobile device attachment assembly and the mobile device in FIG. 1. As shown in FIG. 6, when the mobile device 2 is disposed in the case 200, the main body 110 is disposed in the attachment accommodating part 212 and is simultaneously fixed by the mobile device 2 and the limiting part 214, so it can be firmly accommodated in the attachment accommodating part 212. Further, as shown in FIG. 6, the main body 110 and the extending part 120 are jointly disposed in a recess of the chamfering part 216 and attached to the case 200, so when the user takes the mobile device attachment assembly 1 and the mobile device 2 through the extending part 120 or the hanging component 140, the angle design between the main body 110 and the extending part 120 can reduce the stress concentration, and besides, the recessed design of the chamfering part 216 can more smoothly support the main body 110 and the extending part 120, further prevents excessive bending or stress concentration, thereby increasing the service life of the connecting attachment 100.

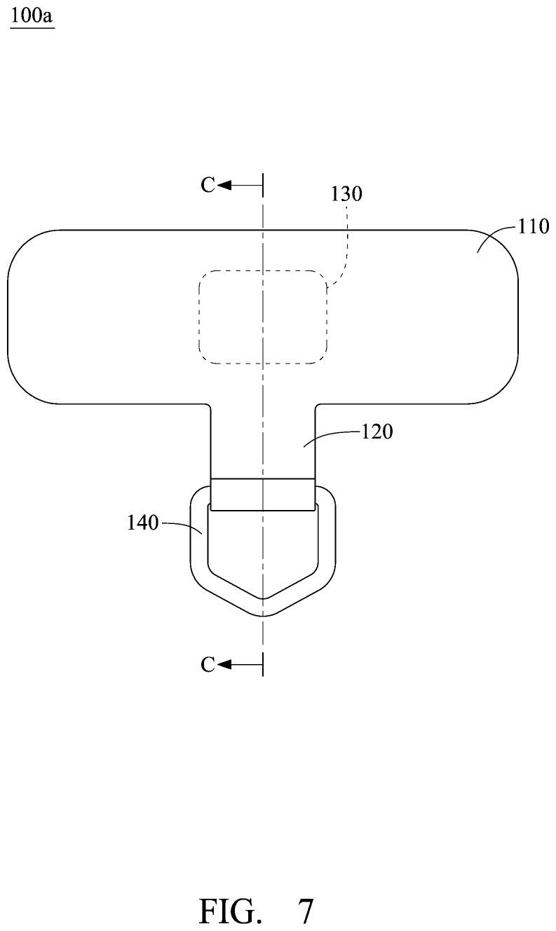

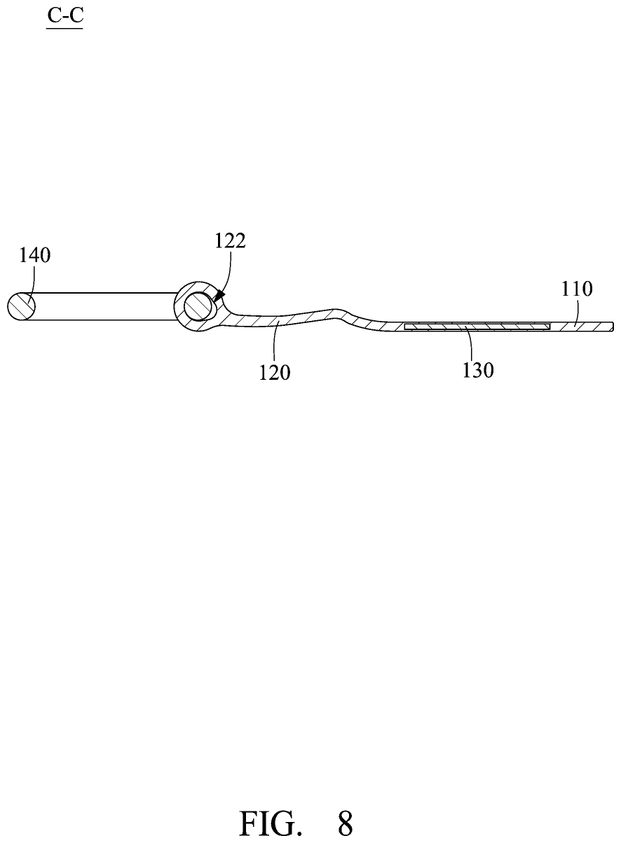

Referring to FIGS. 7 and 8, FIG. 7 is a schematic top view of the connecting attachment of another embodiment of the present disclosure, and FIG. 8 is a sectional view of the connecting attachment along the C-C section of FIG. 7. The connecting attachment 100a of the present embodiment is roughly similar to the connecting attachment 100 of FIG. 2, the main difference between the two is that: the connecting attachment 100a fails to have a printing part 150, and the wireless communicating component 130 of the connecting attachment 100a is buried in the main body 110.

In detail, in the process of manufacturing the connecting attachment 100a, the chip with wireless communication function may be directly disposed between the upper and lower modes, and the wireless communicating component 130 is buried between the upper and lower layers of the main body 110 by hot pressing, and the extending part 120 is disposed on one side of the main body 110. By such a configuration, the main body 110 not only may have further protection of the wireless communicating component 130, but the main body 110 also may maintain a smaller volume when the material of the main body 110 is selected from hard plastics to have a greater rigidity than nylon, and the upper and lower surfaces can also be kept flat, and not easily affected by the thickness of the wireless communicating component 130 and change the appearance contour.

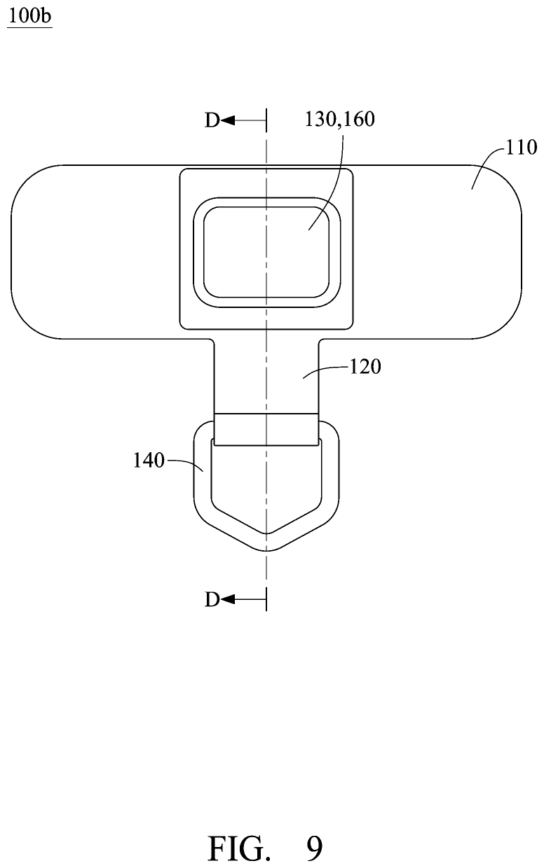

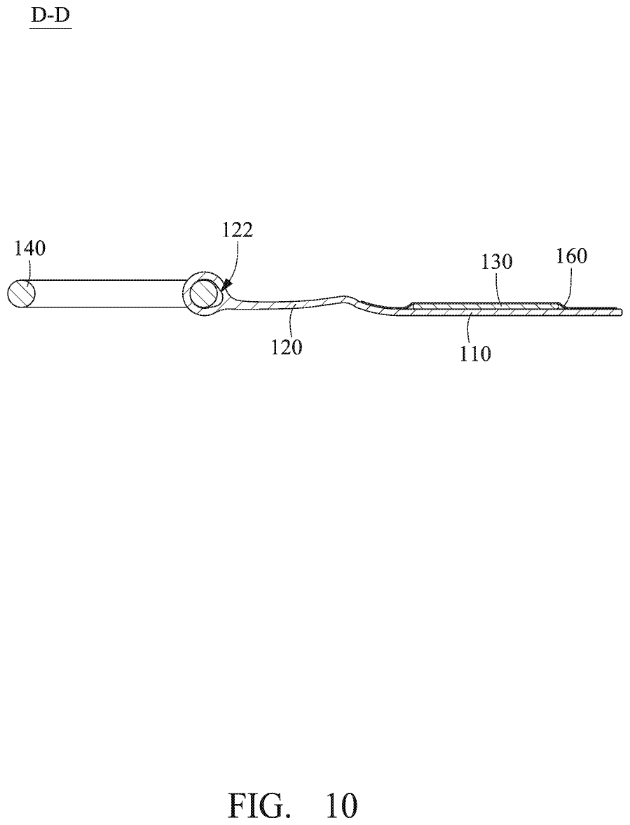

Referring to FIGS. 9 and 10, FIG. 9 is a schematic top view of the connecting attachment of another embodiment of the present disclosure, and FIG. 10 is a schematic sectional view of the connecting attachment along the D-D section of FIG. 9. The connecting attachment 100b of the present embodiment is roughly similar to the connection attachment 100 of FIG. 2, the main difference between the two is that: the connecting attachment 100b fails to have a printing part 150 and includes a bonding part 160, and the wireless communicating component 130 is bonded to the main body 110 through the bonding part 160.

In detail, in order to provide the user with greater freedom of use, the connecting attachment 100b may bond the wireless communicating component 130 on the surface of the main body 110 via an adhesive object (e.g., tape for electronic components), and the extending part 120 is disposed on one side of the main body 110. By such a configuration, when the user wants to use other wireless communicating components 130, the original wireless communicating component 130 may be removed by the bonding part 160 and other wireless communicating components 130 are attached, or other wireless communicating components 130 are directly attached to the other side of the existing bonding part 160 or the main body 110, it is quite convenient for different wireless communication requirements or function expansion of the connecting attachment 100b. At the same time, the bonding part 160 can also be printed with a variety of different patterns or figures thereon, adding the aesthetics of the connecting attachment 100b in use.

While the present invention has been described by means of preferable embodiments, those skilled in the art should understand the above description is merely embodiments of the invention, and it should not be considered to limit the scope of the invention. It should be noted that all changes and substitutions which come within the meaning and range of equivalency of the embodiments are intended to be embraced in the scope of the invention, and without creating conceptual contradictions or structural conflicts, the technical features of the above embodiments may be appropriately combined, replaced, omitted and changed. Therefore, the scope of the invention is defined by the claims.

What is claimed is:

1. A connecting attachment, comprising:
a main body, adapted to be disposed between a mobile device and a case, and the case is configured to detachably accommodate the mobile device;
an extending part, connected to the main body and extruding with respect to the case; and
a wireless communicating component, disposed on the main body.

2. The connecting attachment according to claim 1, wherein the wireless communicating component is printed on a surface of the main body.

3. The connecting attachment according to claim 1, wherein the wireless communicating component is buried in the main body, and the extending part is disposed at one side of the main body.

4. The connecting attachment according to claim 1, further comprising a bonding part, the wireless communicating component is bonded to the main body through the bonding part, and the extending part is disposed at one side of the main body.

5. The connecting attachment according to claim 1, wherein the main body is a rectangular sheet and has two long sides and two short sides adjacent to the two long sides, and the extending part is disposed at one of the two long sides.

6. The connecting attachment according to claim 1, further comprising a hanging component, the extending part comprises two end parts, one of the two end parts is connected to the main body, and the hanging component is disposed at the other of the two end parts.

7. The connecting attachment according to claim 6, wherein the other of the two end parts forms a pierced hole thereon, and the hanging component perforates into the pierced hole.

8. The connecting attachment according to claim 1, wherein a side projection of the main body and a side projection of the extending part have an angle therebetween.

9. The connecting attachment according to claim 1, wherein the case comprises a bottom wall, and the bottom wall forms an attachment accommodating part thereon, the main body is adapted to be disposed in the attachment accommodating part and abutted against the mobile device.

10. The connecting attachment according to claim 9, wherein the case further comprises a side wall, the side wall is connected to a perimeter of the bottom wall and suitable for surrounding the mobile device, the side wall forms a through hole thereon, and the extending part is suitable for perforating into the through hole.

11. A mobile device attachment assembly, comprising:
a case, configured to detachably accommodate a mobile device; and
a connecting attachment as claimed in claim 1, wherein the main body is adapted to be disposed between the mobile device and the case, the extending part is connected to the main body and extrudes with respect to the case.

12. The mobile device attachment assembly according to claim 11, wherein the case comprises a bottom wall, and the bottom wall forms an attachment accommodating part thereon, the main body is adapted to be disposed in the attachment accommodating part and abutted against the mobile device.

13. The mobile device attachment assembly according to claim 12, wherein the case further comprises a side wall, the side wall is connected to a perimeter of the bottom wall and suitable for surrounding the mobile device, the side wall forms a through hole thereon, and the extending part is suitable for perforating into the through hole.

14. The mobile device attachment assembly according to claim 13, wherein a chamfering part is formed between the bottom wall and the side wall, and the chamfering part is recessed between the bottom wall and the through hole.

15. The mobile device attachment assembly according to claim 12, wherein the bottom wall further forms a limiting part thereon, the limiting part is configured to be adjacent to the attachment accommodating part, and at least one portion of the limiting part is protruding relative to a surface of the attachment accommodating part.

16. The mobile device attachment assembly according to claim 12, wherein a surface of the attachment accommodating part forms an anti-slip feature thereon.
